(19) United States
(12) Patent Application Publication
(10) Pub. No.: US 2022/0338193 A1
(43) Pub. Date: Oct. 20, 2022

(54) TEMPORAL SUSPENSION OF NON-IP DATA DELIVERY ON AN EXPOSURE FUNCTION IN A MOBILE TELECOMMUNICATION NETWORK

(71) Applicant: Microsoft Technology Licensing, LLC, Redmond, WA (US)

(72) Inventor: Shantanu DESAI, Bengaluru (IN)

(21) Appl. No.: 17/233,391

(22) Filed: Apr. 16, 2021

(51) Int. Cl. H04W 72/04; H04W 72/12; H04W 4/20

(52) U.S. Cl. CPC H04W 72/0446; H04W 72/1268; H04W 72/1273; H04W 72/1289; H04W 4/20

(57) ABSTRACT

An exposure function in a mobile telecommunication network can receive a plurality of configuration parameters and define a pause window based on the configuration parameters. Non-IP data delivery (NIDD) procedures are suspended during the pause window. The exposure function can receive a request to deliver non-IP data. The exposure function determines whether the request to deliver the non-IP data is received during the pause window. The exposure function denies the request to deliver the non-IP data in response to determining that the request to deliver the non-IP data is received during the pause window. The exposure function allows the request to deliver the non-IP data in response to determining that the request to deliver the non-IP data is received outside of the pause window.

### CROSS-REFERENCE TO RELATED APPLICATIONS

N/A

### BACKGROUND

The Third Generation Partnership Project (3GPP) is a consortium of a number of standards organizations that develop protocols for mobile telecommunications. 3GPP is responsible for the development of Long-Term Evolution (LTE) and related fourth generation (4G) standards, including LTE Advanced and LTE Advanced Pro. 3GPP is also responsible for the development of fifth generation (5G) standards. 5G systems are already being deployed and are expected to become widespread in the near future.

4G standards define a service capability exposure function (SCEF), which provides a way to securely expose the services and capabilities of 3GPP network interfaces. An SCEF enables external applications to connect to devices and nodes in a mobile telecommunication network in a secure way. 5G standards define a network exposure function (NEF), which provides similar functionality. In a 5G NEF, access to exposed network services and capabilities is provided by a set of northbound RESTful (or web-style) APIs from the network domain to both internal (i.e., within the network operator's trust domain) and external applications. The present disclosure will use the term “exposure function” to refer generally to an SCEF or an NEF (or to another equivalent function that performs similar functionality).

One of the services provided by an exposure function is non-IP data delivery (NIDD). NIDD can be used to facilitate data communication between a user equipment (UE) and an application server (AS) that is external to the mobile network. For low power Internet of Things (IoT) devices that send and receive small amounts of data on an infrequent basis, utilizing an Internet Protocol (IP) stack for communicating with an AS can be inefficient. NIDD simplifies the process for connecting IoT devices to an AS.

There are many different scenarios in which NIDD can be used. For example, NIDD is used extensively in the field of industrial automation. Various machines and their parts transmit data (e.g., operational data, statistics, health of one or more parts, etc.) periodically to an AS.

Additionally, there are many different business cases where external applications can be used to communicate with UEs via the packet core network and send them non-IP data. An example of such a business case is a bicycle sharing service in which an end user is able to lock/unlock a bicycle using an application on the user's mobile device.

Before an NIDD transfer via an exposure function can occur, two registration steps can be performed: one by the application server (AS), and another by the user equipment (UE). The AS can register with the exposure function, assigning itself as the AS for a particular UE. The UE can register with the exposure function, indicating the availability of a bearer for the exposure function to reach the UE. In this context, the term “bearer” can refer to a connection between the exposure function and a mobility entity, such as a mobility management entity (MME) or a core access and mobility management function (AMF).

The process in which an AS registers with an exposure function can be referred to as NIDD configuration. During NIDD configuration, the AS sends one or more NIDD configuration messages to the exposure function.

In the context of NIDD, a mobile-terminated data request (TDR) refers to the transmission of data from an AS to a UE via an exposure function. Conversely, a mobile-originated data request (ODR) refers to the transmission of data from a UE to an AS via an exposure function. Stated another way, TDR refers to downlink data delivery, whereas ODR refers to uplink data delivery.

The subject matter in the background section is intended to provide an overview of the overall context for the subject matter disclosed herein. The subject matter discussed in the background section should not be assumed to be prior art merely as a result of its mention in the background section. Similarly, a problem mentioned in the background section or associated with the subject matter of the background section should not be assumed to have been previously recognized in the prior art.

### SUMMARY

One aspect of the present disclosure is directed to a method for enabling non-IP data delivery (NIDD) procedures to be suspended and resumed. The method is implemented by an exposure function in a mobile telecommunication network. The method includes receiving a plurality of configuration parameters and defining a pause window based on the plurality of configuration parameters. The NIDD procedures are suspended during the pause window. The method also includes receiving a request to deliver non-IP data and determining whether the request to deliver the non-IP data is received during the pause window. In response to determining that the request to deliver the non-IP data is received during the pause window, the method includes denying the request to deliver the non-IP data. In response to determining that the request to deliver the non-IP data is received outside of the pause window, the method includes allowing the request to deliver the non-IP data.

In some embodiments, the plurality of configuration parameters can comprise a pause time parameter that indicates a start time for the pause window, a pause duration parameter that indicates a duration of the pause window, and a pause frequency parameter that indicates how frequently the pause window should be repeated.

In some embodiments, the plurality of configuration parameters can apply to both downlink communications and uplink communications.

In some embodiments, the plurality of configuration parameters can apply to only one of downlink communications or uplink communications.

In some embodiments, the method can additionally include resetting the pause time parameter based at least in part on the pause frequency parameter in response to expiration of the pause window.

In some embodiments, the plurality of configuration parameters can be received from at least one of an application server (AS), a service capability server (SCS), or an application function (AF).

In some embodiments, the plurality of configuration parameters can be received from a network operator.

In some embodiments, the request to deliver the non-IP data can be a mobile originated data request.

In some embodiments, the request to deliver the non-IP data can be a mobile terminated data request.

In some embodiments, the method can additionally include sending an error message to an entity that sent the request to deliver the non-IP data. The error message can indicate when the request to deliver the non-IP data should be retried.

In some embodiments, the exposure function can be selected from the group consisting of a service capability exposure function (SCEF) and a network exposure function (NEF).

In some embodiments, the method can additionally include receiving an updated value for at least one of the plurality of configuration parameters and modifying the pause window based on the updated value.

Another aspect of the present disclosure is directed to a system for enabling non-IP data delivery (NIDD) procedures to be suspended and resumed. The system includes one or more processors and memory in electronic communication with the one or more processors. A plurality of configuration parameters are stored in the memory. The plurality of configuration parameters define a pause window during which the NIDD procedures are suspended. The system also includes instructions stored in the memory. The instructions are executable by the one or more processors to receive a request to deliver non-IP data and determine whether the request to deliver the non-IP data is received during the pause window. The instructions are also executable by the one or more processors to deny the request to deliver the non-IP data in response to determining that the request to deliver the non-IP data is received during the pause window. The instructions are also executable by the one or more processors to allow the request to deliver the non-IP data in response to determining that the request to deliver the non-IP data is received outside of the pause window.

In some embodiments, the plurality of configuration parameters can comprise a pause time parameter that indicates a start time for the pause window, a pause duration parameter that indicates a duration of the pause window, and a pause frequency parameter that indicates how frequently the pause window should be repeated.

In some embodiments, the instructions can be additionally executable by the one or more processors to, in response to expiration of the pause window, reset the pause time parameter based at least in part on the pause frequency parameter.

In some embodiments, the request to deliver the non-IP data can be a mobile originated data request.

In some embodiments, the request to deliver the non-IP data can be a mobile terminated data request.

In some embodiments, the instructions can be additionally executable by the one or more processors to send an error message to an entity that sent the first data request. The error message can indicate when the first data request should be retried.

In some embodiments, the system can additionally include an access point that is configured in accordance with the plurality of configuration parameters for a group of subscribers.

Another aspect of the present disclosure is directed to a method for enabling non-IP data delivery (NIDD) procedures to be suspended and resumed. The method includes configuring an exposure function with a plurality of configuration parameters that define a pause window during which the NIDD procedures are suspended. The method additionally includes sending a first data request to the exposure function during the pause window and receiving an error message from the exposure function in response to the first data request. The method additionally includes sending a second data request to the exposure function outside of the pause window and receiving an acknowledgement from the exposure function in response to the second data request.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 illustrates an example of a system in which the techniques disclosed herein can be utilized.

FIG. 2 illustrates an example of a method for enabling non-IP data delivery (NIDD) procedures performed by an exposure function to be suspended and resumed.

FIG. 3 illustrates another example of a system in which the techniques disclosed herein can be utilized, including a plurality of different sets of NIDD configuration parameters.

FIG. 4 illustrates an example of a method for enabling NIDD procedures performed by an exposure function to be suspended and resumed in connection with downlink data delivery.

FIG. 5 illustrates an example of a method for enabling NIDD procedures performed by an exposure function to be suspended and resumed in connection with uplink data delivery.

FIG. 6 illustrates an example of a method in a 5G network for enabling NIDD procedures performed by an exposure function to be suspended and resumed in connection with downlink data delivery.

FIG. 7 illustrates an example of a method in a 5G network for enabling NIDD procedures performed by an exposure function to be suspended and resumed in connection with uplink data delivery.

FIG. 8 illustrates certain components that can be included within a computing device.

### DETAILED DESCRIPTION

The present disclosure is generally related to the use of non-IP data delivery (NIDD) in a mobile telecommunications network. The techniques disclosed herein can be utilized by a service capability exposure function (SCEF) in a 4G network and/or a network exposure function (NEF) in a 5G network. As noted above, the term “exposure function” will be used herein to refer generally to an SCEF or an NEF.

Under certain circumstances, it can be desirable to be able to suspend and resume NIDD procedures performed by an exposure function. Two use cases will be described that illustrate this point.

The first use case involves downlink data delivery. More specifically, the first use case is related to a bicycle-sharing service in which bicycles are made available for shared use to individuals on a short-term basis, typically for a small fee. Many bicycle-sharing services allow people to borrow a bicycle from a “dock” and return it to another dock belonging to the same service. In this context, docks are special racks that can lock the bicycle and release it by computer control. With such a service, a user can unlock a bicycle using his or her mobile application and lock it using the same application after the user's ride is finished. In this use case an individual bicycle is an IoT device (user equipment), and the person (subscriber) who wants to ride the bicycle has a mobile application.

A bicycle sharing service can include four phases. The first phase can include the initial exposure of the service. For example, the bicycle can transmit its physical location via a global positioning system (GPS) transceiver. The second phase can include NIDD configuration. In this phase the bicycle can be configured for connectivity and then onboarded. An indication about the bicycle can be displayed on a subscriber's mobile application. The third phase can include the start of the service. The subscriber can unlock the bicycle using the mobile application (using NIDD TDR), and then ride the bicycle to a destination. The fourth phase can include the end of the service. The subscriber can lock the bicycle at the destination (using NIDD ODR).

In this use case involving a bicycle sharing service, there are many different scenarios in which it might be desirable to restrict the usage of the bicycle by the user. For example, it might be desirable to restrict the usage at nighttime (e.g., between 11:00 p.m. and 6:00 a.m.). As another example, it might be desirable to restrict the usage in certain areas (e.g., where construction or a major rally is happening). As yet another example, it might be desirable to restrict the usage in some areas due to an emergency and/or law-and-order situation.

The second use case that will be described involves uplink data delivery. More specifically, the second use case is related to an industrial automation scenario in which operators can provide self-healing capabilities to the UEs, which can include industrial equipment. The self-healing capabilities can be provided based on some indication from the AS via an exposure function (e.g., SCEF or NEF). Alternatively, the UEs can transmit some data to the AS for analytics and reporting.

In this use case involving industrial automation, there are many different scenarios in which it might be desirable to restrict communication between the UEs and the AS. For example, it might be desirable to restrict the capability of self-healing at a designated time due to maintenance or other constraints in operation. As another example, it might be desirable to restrict the capability of the individual UEs to communicate with the AS at a designated time on a periodic (e.g., daily) basis due to constraints in the operation. For instance, it could be beneficial to save power by stopping production at night.

There are currently three approaches for suspending and resuming NIDD procedures for downlink data delivery. A first approach involves hard coding the time restrictions in the mobile application itself. For example, if it is desired to restrict downlink data delivery between a certain time period (e.g., between 11:00 p.m. and 6:00 a.m.), this time restriction could be hard coded in the mobile application. Although this approach does not require any infrastructure support from the core network, it would be necessary to release an updated version of the application if the time period for the restriction needs to change. It would also be necessary to have a custom release for emergency/ad hoc blocking of the service.

A second approach for suspending and resuming NIDD procedures for downlink data delivery involves an AS sending NIDD configuration messages at the times when NIDD procedures are supposed to start and stop. Consider the example described above in which it is desired to restrict usage of the bicycle sharing service between the hours of 11:00 p.m. and 6:00 a.m. This could be accomplished by causing the AS to send a message that deletes an existing configuration (e.g., an NIDD-Config-Delete request) at 11:00 p.m., and then causing the AS to send another message that creates a new configuration (e.g., an NIDD-Config-Create request) at 6:00 a.m. As with the first approach described previously, this second approach does not require any infrastructure support from the core network. However, it creates significantly more overhead for both the AS and the exposure function. The additional overhead for the AS includes the additional NIDD configuration messages that the AS needs to send, all of which significantly increase network signaling. The overhead for the exposure function includes the additional overhead involved in creating and deleting subscribers in response to the NIDD configuration messages sent by the AS.

A third approach for suspending and resuming NIDD procedures for downlink data delivery involves connecting to an external server from the mobile application and reading policies from the server to keep the service unavailable at designated time(s). As with the first and second approach described previously, this third approach does not require any infrastructure support from the core network. However, the service provider is required to maintain the policies externally, and a polling or publication/subscription mechanism is required in the mobile application to retrieve the policies.

There is currently one approach for suspending and resuming NIDD procedures for uplink data delivery. It is similar to the second approach discussed above, in which an AS sends NIDD configuration messages at the times when NIDD procedures are supposed to start and stop. Whenever an operator wants to pause the uplink data delivery for a particular subscriber, the AS can send a message to the exposure function that deletes an existing configuration (e.g., an NIDD-Config-Delete request) for the corresponding subscriber. Similarly, whenever an operator wants to unpause the uplink data delivery for a particular subscriber, the AS can send a message to the exposure function that creates an existing configuration (e.g., an NIDD-Config-Create request) for the corresponding subscriber. As discussed above, although this approach does not require any infrastructure support from the core network, it creates significantly more overhead for both the AS and the exposure function. The additional overhead for the AS includes the additional NIDD configuration messages that the AS needs to send, all of which significantly increase network signaling. The overhead for the exposure function includes the additional overhead involved in creating and deleting subscribers in response to the NIDD configuration messages sent by the AS.

As can be seen, although it is possible to suspend and resume NIDD procedures, the existing mechanisms for doing so have significant drawbacks, including additional network signaling and overhead.

The present disclosure proposes techniques that enable NIDD procedures performed by an exposure function to be suspended and resumed. Advantageously, the techniques disclosed herein enable NIDD procedures to be suspended and resumed for both downlink data delivery and uplink data delivery. In addition, the techniques disclosed herein enable NIDD procedures to be suspended and resumed without the additional signaling and overhead that is required by current approaches.

In accordance with the present disclosure, an exposure function (e.g., an SCEF or an NEF) can be configured with certain parameters that enable NIDD procedures to be suspended and resumed. In some embodiments, an exposure function can be configured with at least three parameters: an NIDD pause time parameter, an NIDD pause duration parameter, and an NIDD pause frequency parameter. The NIDD pause time parameter can indicate a start time at which NIDD operations on the exposure function should be paused. The NIDD pause duration parameter can indicate the duration for which the NIDD operations on the exposure function should remain paused. The NIDD pause frequency parameter can indicate the frequency at which pausing of the NIDD operations should occur.

Configuring an exposure function with the parameters just described can have the effect of creating a pause window for a subscriber or a group of subscribers. In this context, the term pause window can refer to a time period during which NIDD operations are paused. The NIDD pause time parameter can indicate the start time of the pause window. The NIDD pause duration parameter can indicate the duration of the pause window. The NIDD pause frequency parameter can indicate how frequently the pause window should be repeated.

Configuring an exposure function with the parameters just described can enable NIDD procedures to be paused and unpaused. Advantageously, the pausing and unpausing of the NIDD procedures can be scheduled in advance. Under some circumstances, the pausing and unpausing of the NIDD procedures can be scheduled to occur on a recurring or an ongoing basis.

The current approaches for suspending and resuming NIDD procedures for downlink data delivery (as described above) are more or less external to the exposure function (e.g., SCEF, NEF). In contrast, the techniques disclosed herein enable the exposure function itself to pause and unpause NIDD procedures so that applications do not need to create custom solutions for desired use cases. Facilitating control of NIDD procedures via an exposure function provides a network operator with flexibility to apply suspension/resumption policies independent of an application server. Network operators can therefore optimize their network resources without having to rely on external applications to perform these operations for them.

Another potential benefit of the techniques disclosed herein is that the NIDD configuration parameters only have to be defined once (e.g., during an initial NIDD configuration procedure) in order to create a recurring pause window. This is significantly simpler than with some current approaches, where (as discussed above) configuration messages have to be sent each time that NIDD procedures should be paused or resumed.

In some embodiments, the NIDD configuration parameters described above can apply to both downlink and uplink data delivery. In other words, configuring an exposure function with the NIDD pause time parameter, the NIDD pause duration parameter, and the NIDD pause frequency parameter can cause NIDD operations to be suspended in both the downlink direction and the uplink direction.

In some embodiments, NIDD configuration parameters can be defined that cause NIDD procedures to be paused in one direction only (i.e., either downlink or uplink instead of both downlink and uplink). For example, one set of NIDD configuration parameters can be defined for the uplink, and another set of NIDD configuration parameters can be defined for the downlink. The NIDD configuration parameters that are defined for the uplink can include an NIDD pause time parameter for the uplink, an NIDD pause duration parameter for the uplink, and an NIDD pause frequency parameter for the uplink. The NIDD configuration parameters that are defined for the downlink can include an NIDD pause time parameter for the downlink, an NIDD pause duration parameter for the downlink, and an NIDD pause frequency parameter for the downlink. Configuring an exposure function with the uplink NIDD configuration parameters can have the effect of creating a pause window for uplink communications without affecting downlink communications. Similarly, configuring an exposure function with the downlink NIDD configuration parameters can have the effect of creating a pause window for downlink communications without affecting uplink communications.

In some embodiments, one set of NIDD configuration parameters can be defined that applies to both uplink and downlink communications, another set of NIDD configuration parameters can be defined that applies to uplink communications only, and another set of NIDD configuration parameters can be defined for that applies to downlink communications only.

In some embodiments, the parameters just described can apply to a particular subscriber or to a group of subscribers. There are many different ways that a subscriber can be identified. In some embodiments, a subscriber can be identified using a Mobile Station International Subscriber Directory Number (MSISDN). In some embodiments, a subscriber can be identified by an external identifier.

In a scenario where it would be desirable for the pausing and unpausing of NIDD procedures to apply to a group of subscribers, the parameters just described can be provided as a configuration option under the access point name (APN) configuration so as to provide grouped capability per APN. Rules can be defined to resolve any conflicts between configuration parameters that are provided for a particular subscriber and configuration parameters that are provided for a particular APN. In some embodiments, configuration parameters that are provided for a particular subscriber can always take precedence over configuration parameters that are provided for a particular APN.

The NIDD pause time parameter can be expressed in terms of an absolute time that occurs at some point in the future. In some embodiments, the NIDD pause time parameter can be expressed in the format dd.mm.yyyy:hh.mm.ss. In this example, if the value of the NIDD pause time parameter is 20.09.2021:22.00.00, this means that NIDD operations should be paused beginning at 10:00 p.m. on Sep. 20, 2021.

The NIDD pause duration parameter can be expressed in any desired unit of time (e.g., seconds, minutes, hours). As an example, if the NIDD pause duration parameter is expressed in units of seconds and the value of the NIDD pause duration parameter is 3600 seconds, this means that NIDD operations on the exposure function should remain paused for 3600 seconds (which is equivalent to sixty minutes, or one hour) after the start time indicated by the NIDD pause time parameter.

The NIDD pause frequency parameter can also be expressed in any desired unit of time (e.g., seconds, minutes, hours). As an example, if the NIDD pause frequency parameter is expressed in units of seconds and the value of the NIDD pause duration parameter is 86400 seconds, this means that NIDD operations on the exposure function should be paused every 86400 seconds (which is equivalent to 1440 minutes, or 24 hours, or one day) after the time indicated by the NIDD pause time parameter and for the duration indicated by the NIDD pause duration parameter. Thus, if the value of the NIDD pause time parameter is 20.09.2021:22.00.00, the value of the NIDD pause duration parameter is 3600 seconds (or one hour), and the value of the NIDD pause frequency parameter is 86400 seconds (or one day), this means that NIDD operations on the exposure function should be paused for one hour every night, between 10:00 p.m. and 11:00 p.m., beginning on Sep. 20, 2021. Thus, the NIDD pause frequency parameter allows pausing of NIDD procedures in recurring intervals without the need to send separate NIDD configuration delete/create/update messages.

Whenever an exposure function that has been configured with these parameters receives a downlink or uplink data transfer request, the exposure function can check to see whether the request is received during a pause window (i.e., during a period of time when NIDD operations are suspended). If the request is received outside of a pause window, the request can be allowed. However, if the request is received during the pause window, the request can be buffered or discarded.

In some embodiments, when an exposure function discards a data request, the exposure function can return an error message to the entity that sent the request. The error message can indicate, among other things, a time when the request should be retried. The time can be determined by calculating the amount of time remaining in the pause window.

In some embodiments, at the end of a particular pause window (i.e., when NIDD procedures should be resumed after being paused for some period of time), the NIDD pause time parameter can be reset based on the NIDD pause frequency parameter. This can have the effect of creating a recurring pause window. In the example described above (where the value of the NIDD pause time parameter is 20.09.2021:22.00.00, the value of the NIDD pause duration parameter is 3600 seconds or one hour, and the value of the NIDD pause frequency parameter is 86400 seconds or one day), an initial pause window can extend from 10:00 p.m. until 11:00 p.m. on Sep. 20, 2021. When that initial pause window expires at 11:00 p.m. on Sep. 20, 2021, then the value of the NIDD pause time parameter can be reset by adding the value of the NIDD pause frequency parameter to the previous value of the NIDD pause time parameter. In other words, 86400 seconds (or one day) can be added to the NIDD pause time parameter, so that the new value of the NIDD pause time parameter is 21.09.2021:22.00.00 (or 10:00 p.m. on Sep. 21, 2021).

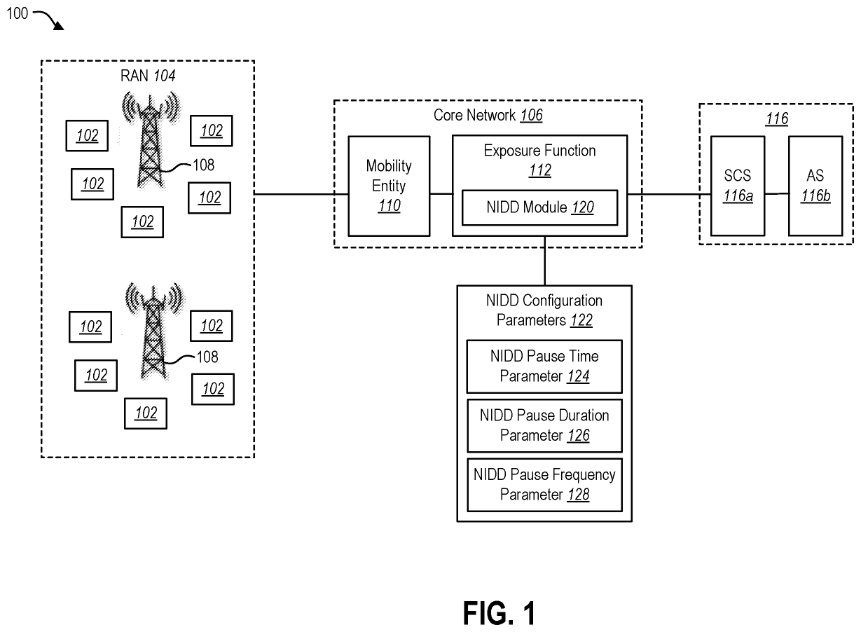

FIG. 1 illustrates an example of a system 100 in which the techniques disclosed herein can be utilized. In the depicted example, the system 100 is a mobile telecommunication system that provides wireless connectivity to mobile devices. The mobile devices may be referred to as user equipment (UE) 102. The system 100 can include many different types of UEs 102. Some examples of UEs 102 include smartphones, tablet computers, laptop computers, cars, drones, industrial and agricultural machines, robots, home appliances, and medical devices.

The system 100 includes a radio access network (RAN) 104 and a core network 106. The RAN 104 enables the UEs 102 to connect to the core network 106. The RAN 104 includes a distributed collection of base stations 108.

FIG. 1 shows some of the components of the core network 106 that are relevant to the techniques disclosed herein, including a mobility entity 110 and an exposure function 112. The mobility entity 110 can be configured to track and manage the movement of UEs 102 throughout the RAN 104. The exposure function 112 can be configured to securely expose the services and capabilities of various network interfaces, including network interfaces corresponding to the core network 106.

The core network 106 can be implemented using a wide variety of mobile telecommunication technologies, including fourth generation (4G) technologies and/or fifth generation (5G) technologies. In a 4G network, the mobility entity 110 can be implemented as a mobility management entity (MME), and the exposure function 112 can be implemented as a service capability exposure function 112 (SCEF). In a 5G network, the mobility entity 110 can be implemented as a core access and mobility management function (AMF), and the exposure function 112 can be implemented as a network exposure function 112 (NEF).

The system 100 is also shown with a service capability server (SCS) 116a and an application server (AS) 116b. The AS 116b can be configured to send non-IP data to and receive non-IP data from the UEs 102. The SCS 116a can be configured to act as a gateway between the AS 116b and other components in the core network 106. The SCS 116a and the AS 116b may be referred to herein collectively as an SCS/AS 116.

The exposure function 112 can be configured to perform non-IP data delivery (NIDD). FIG. 1 shows the exposure function 112 with an NIDD module 120. The NIDD module 120 is intended to represent the NIDD procedures and operations that are performed by the exposure function 112.

In accordance with the present disclosure, the exposure function 112 can be configured based at least in part on a plurality of NIDD configuration parameters 122. The NIDD configuration parameters 122 can include an NIDD pause time parameter 124, an NIDD pause duration parameter 126, and an NIDD pause frequency parameter 128. The NIDD configuration parameters 122 can define a pause window during which the NIDD procedures performed by the exposure function 112 are suspended. As discussed above, the NIDD pause time parameter 124 can indicate the time when the pause window begins. The NIDD pause duration parameter 126 can indicate the duration of the pause window. The NIDD pause frequency parameter 128 can indicate how frequently the pause window should be repeated.

In some embodiments, the SCS/AS 116 can configure the exposure function 112 with the NIDD configuration parameters 122. For example, the SCS/AS 116 can send an NIDD configuration message to the exposure function 112, and the NIDD configuration message can include the NIDD configuration parameters 122. Alternatively, a network operator can configure the exposure function 112 with the NIDD configuration parameters 122. In the case of configuration by a network operator, the SCS/AS 116 might not be aware that the exposure function 112 has been configured with the NIDD configuration parameters 122.

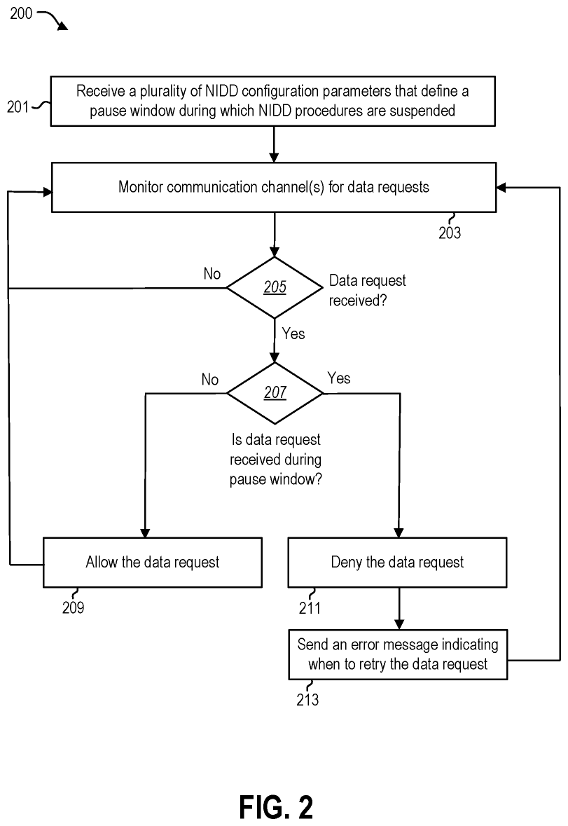

FIG. 2 illustrates an example of a method 200 for enabling NIDD procedures performed by an exposure function 112 to be suspended and resumed. The method 200 can be implemented by an exposure function 112. For clarity, the method 200 will be described in relation to the system 100 shown in FIG. 1.

In accordance with the method 200, the exposure function 112 can receive 201 a plurality of NIDD configuration parameters 122. As discussed above, the NIDD configuration parameters 122 can define a pause window during which the NIDD procedures performed by the exposure function 112 are suspended. The NIDD configuration parameters 122 can include an NIDD pause time parameter 124 that indicates when the pause window begins, an NIDD pause duration parameter 126 that indicates the duration of the pause window, and an NIDD pause frequency parameter 128 that indicates how frequently the pause window is repeated.

In some embodiments, the exposure function 112 can receive 201 the NIDD configuration parameters 122 from an SCS/AS 116 in an NIDD configuration message. Alternatively, the exposure function 112 can receive 201 the NIDD configuration parameters 122 from a network operator.

The method 200 can include monitoring 203 one or more communication channels for data requests. The depicted method 200 enables NIDD procedures to be suspended and resumed for both downlink data delivery and uplink data delivery. Thus, monitoring 203 the communication channel(s) for data requests can include monitoring 203 the communication channel(s) for mobile-terminated data requests (TDRs) and/or mobile-originated data requests (ODRs). TDRs can be received from an SCS/AS 116, whereas ODRs can be received from a mobility entity 110 (e.g., an MME or AMF).

When it is determined 205 that a data request (e.g., a TDR or an ODR) has been received, the exposure function 112 can determine 207 whether the data request is received during a pause window as defined by the NIDD configuration parameters 122. If the exposure function 112 determines 207 that the data request is not received during a pause window, the exposure function 112 can allow 209 the data request. For example, if the data request is a TDR received from an SCS/AS 116, the exposure function 112 can forward the TDR to a mobility entity 110. If the data request is an ODR received from a mobility entity 110, the exposure function 112 can forward the ODR to an SCS/AS 116.

On the other hand, if the exposure function 112 determines 207 that the data request is received during a pause window, the exposure function 112 can deny 211 the data request. In some embodiments, when the exposure function 112 denies 211 a data request, the exposure function 112 can send 213 an error message to the entity that sent the data request. For example, if the data request is a TDR received from an SCS/AS 116, the exposure function 112 can send an error message to the SCS/AS 116. If the data request is an ODR received from a mobility entity 110, the exposure function 112 can send an error message to the mobility entity 110. In either case, the error message can indicate when the request should be retried.

In some embodiments, the pause window can be modified by changing the value of one or more configuration parameters. For example, suppose that a recurring pause window is created each evening from 7:00 p.m. to 9:00 p.m. Such a pause window can be created by setting the NIDD pause time parameter 124 equal to 7:00 p.m. on the date when the pause window should start, the NIDD pause duration parameter 126 to two hours, and the NIDD pause frequency parameter 128 to twenty four hours. Further suppose that at a subsequent point in time it becomes desirable to change the pause window so that it extends from 7:00 p.m. until 10:00 p.m. Such a modification can be made by changing the value of the NIDD pause duration parameter 126 to three hours.

In the previous example, only one of the NIDD configuration parameters 122 was changed. However, in some embodiments, more than one of the NIDD configuration parameters 122 can be changed. For example, if it subsequently becomes desirable to change the pause window so that it extends from 6:00 p.m. until 10:00 p.m., the value of the NIDD pause time parameter 124 can be changed to 6:00 p.m. and the value of the NIDD pause duration parameter 126 can be changed to four hours. If it subsequently becomes desirable for the pause window to recur every other day, the value of the NIDD pause frequency parameter 128 can be changed to forty eight hours.

In some embodiments, the values of NIDD configuration parameters 122 can be modified by the SCS/AS 116. In some embodiments, the values of NIDD configuration parameters 122 can be modified by a network operator independently of the SCS/AS 116.

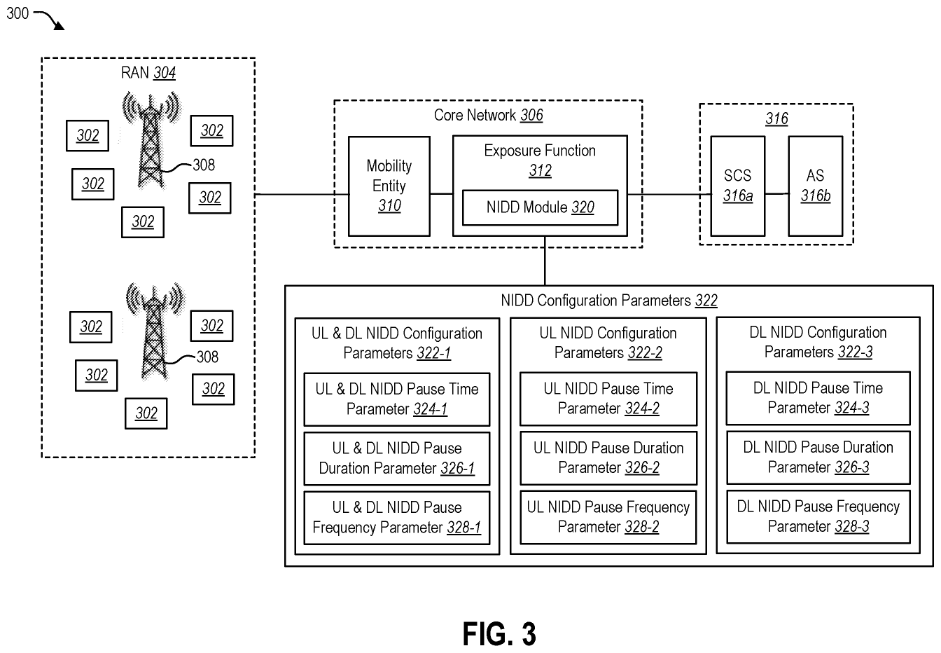

FIG. 3 illustrates another example of a system 300 in which the techniques disclosed herein can be utilized. The system 300 shown in FIG. 3 is similar in many respects to the system 100 shown in FIG. 1. The system 300 is a mobile telecommunication system that provides wireless connectivity to a plurality of UEs 302. The system 300 includes a RAN 304 that enables the UEs 302 to connect to the core network 306. The RAN 304 includes a distributed collection of base stations 308. The core network 306 includes a mobility entity 310 that tracks and manages the movement of UEs 302 throughout the RAN 304. The core network 306 also includes an exposure function 312 that securely exposes the services and capabilities of network interfaces. The exposure function 312 includes an NIDD module 320 that represents the NIDD procedures and operations that are performed by the exposure function 312. An AS 316b can be configured to send non-IP data to and receive non-IP data from the UEs 302. An SCS 316a can be configured to act as a gateway between the AS 316b and other components in the core network 306. The SCS 316a and the AS 316b may be referred to herein collectively as an SCS/AS 316.

As discussed above, in accordance with the present disclosure the exposure function 312 can be configured based at least in part on a plurality of NIDD configuration parameters 322. Configuring the exposure function 312 with the NIDD configuration parameters 322 can have the effect of creating a pause window for a subscriber or a group of subscribers.

FIG. 3 shows three different sets of configuration parameters with which the exposure function 312 can be configured: uplink (UL) and downlink (DL) NIDD configuration parameters 322-1, UL NIDD configuration parameters 322-2, and DL NIDD configuration parameters 322-3. The UL and DL NIDD configuration parameters 322-1 include a UL and DL NIDD pause time parameter 324-1, a UL and DL NIDD pause duration parameter 326-1, and a UL and DL NIDD pause frequency parameter 328-1. The UL NIDD configuration parameters 322-2 include a UL NIDD pause time parameter 324-2, a UL NIDD pause duration parameter 326-2, and a UL NIDD pause frequency parameter 328-2.

The UL and DL NIDD configuration parameters 322-1 can apply to both downlink and uplink data delivery. In other words, configuring the exposure function 312 with the UL and DL NIDD pause time parameter 324-1, the UL and DL NIDD pause duration parameter 326-1, and the UL and DL NIDD pause frequency parameter 328-1 can cause NIDD operations to be suspended and resumed in the manner described above in both the downlink direction and the uplink direction.

The UL NIDD configuration parameters 322-2 can apply to uplink data delivery only. In other words, configuring the exposure function 312 with the UL NIDD pause time parameter 324-2, the UL NIDD pause duration parameter 326-2, and the UL NIDD pause frequency parameter 328-2 can cause NIDD operations to be suspended and resumed in the manner described above in the uplink direction without affecting NIDD communications in the downlink direction.

The DL NIDD configuration parameters 322-3 can apply to downlink data delivery only. In other words, configuring the exposure function 312 with the DL NIDD pause time parameter 324-3, the DL NIDD pause duration parameter 326-3, and the DL NIDD pause frequency parameter 328-3 can cause NIDD operations to be suspended and resumed in the manner described above in the downlink direction without affecting NIDD communications in the uplink direction.

In some embodiments, the exposure function 312 can be configured using only the UL and DL NIDD configuration parameters 322-1. In embodiments where more granular control is desired, the uplink and downlink can be configured separately using the UL NIDD configuration parameters 322-2 and the DL NIDD configuration parameters 322-3, respectively.

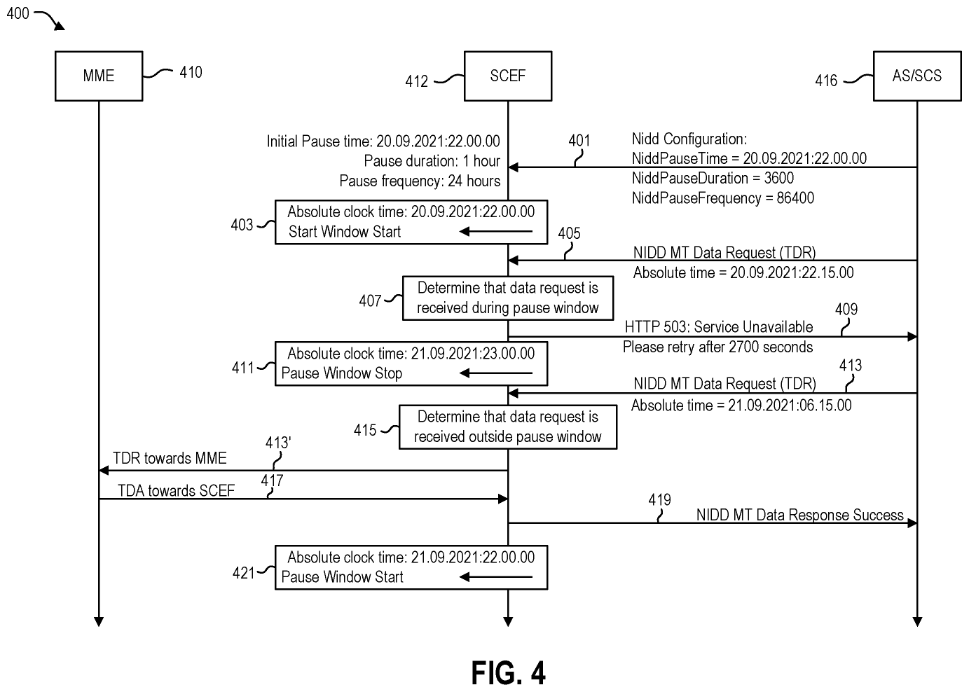

FIG. 4 illustrates an example of a method 400 for enabling NIDD procedures performed by an exposure function to be suspended and resumed in connection with downlink data delivery. The method 400 will be described in relation to an SCEF 412, an MME 410, and an AS/SCS 416. The SCEF 412 is an example of the exposure function 112 in the system 100 shown in FIG. 1. The MME 410 is an example of the mobility entity 110 in the system 100 shown in FIG. 1.

For the sake of clarity, specific values are provided in the example shown in FIG. 4 (and also in subsequent figures). However, these specific values should not be interpreted as limiting the scope of the present disclosure. One skilled in the art would understand that a wide range of values could be used for the parameters being described, and that the specific values shown in the figures are provided solely for the purpose of illustrating certain features of the disclosed embodiments.

In accordance with the method 400, the AS/SCS 416 can send the SCEF 412 an NIDD configuration message 401. The NIDD configuration message 401 can include an NIDD pause time parameter (NiddPauseTime), an NIDD pause duration parameter (NiddPauseDuration), and an NIDD pause frequency parameter (NiddPauseFrequency).

In some embodiments, the NIDD configuration parameters in the NIDD configuration message 401 can apply to both uplink and downlink communications. For example, the NIDD configuration parameters in the NIDD configuration message 401 can be UL & DL NIDD configuration parameters (such as the UL & DL NIDD configuration parameters 322-1 shown in FIG. 3).

In some embodiments, the NIDD configuration parameters in the NIDD configuration message 401 can apply to downlink communications only. For example, the NIDD configuration parameters in the NIDD configuration message 401 can be DL NIDD configuration parameters (such as the DL NIDD configuration parameters 322-3 shown in FIG. 3).

For purposes of the present example, it will be assumed that the value of the NIDD pause time parameter is 20.09.2021:22.00.00, the value of the NIDD pause duration parameter is 3600 seconds (or one hour), and the value of the NIDD pause frequency parameter is 86400 seconds (or 24 hours).

All times that are described in connection with the present method 400 (and also other methods disclosed herein) can be determined based on a clock utilized by a computing device on which the SCEF 412 is running.

The SCEF 412 can start 403 the pause window at the time indicated by the NIDD pause time parameter. Thus, in the present example, when the current time is 10:00 p.m. on Sep. 20, 2021, the SCEF 412 can start 403 the pause window. The pause window can be scheduled to continue for the length of the NIDD pause duration parameter, which in this example is 3600 seconds (or one hour). Thus, the pause window can be scheduled to last from 10:00 p.m. until 11:00 p.m. in the present example.

At some point after the SCEF 412 has started 403 the pause window, the AS/SCS 416 can send the SCEF 412 an NIDD mobile-terminated (MT) data request 405. For purposes of the present example, it will be assumed that the NIDD MT data request 405 is received by the SCEF 412 at 20.09.2021:22.15.00. In other words, the SCEF 412 receives the NIDD MT data request 405 at 10:15 p.m. on Sep. 20, 2021.

In response to receiving the NIDD MT data request 405, the SCEF 412 determines 407 whether the NIDD MT data request 405 is received during a pause window (as defined by the NIDD configuration parameters that were received in the NIDD configuration message 401). As discussed above, in the present example the pause window extends from 10:00 p.m. until 11:00 p.m. each evening beginning on Sep. 20, 2021. Thus, in the present example, the NIDD MT data request 405 is received during a pause window.

Because the NIDD MT data request 405 is received during a pause window, the SCEF 412 returns an error message 409 to the AS/SCS 416. The error message 409 can indicate that the NIDD MT data request 405 is being denied. The error message 409 can include an error code, which in the present example is “HTTP 503: Service Unavailable.” In addition, the error message 409 can also indicate a time when the request should be retried. The time when the request should be retried can be determined by calculating the amount of time remaining in the pause window. In the present example, calculating the amount of time remaining in the pause window can include subtracting the time when the NIDD MT data request 405 is received (which is 20.09.2021:22.15.00 in this example) from the time when the pause window is scheduled to end (which is 20.09.2021:23.00.00 in this example). Thus, in the present example, the amount of time remaining in the pause window is 45 minutes, or 2700 seconds. Therefore, the error message 409 that the SCEF 412 returns to the AS/SCS 416 can indicate that the NIDD MT data request 405 can be retried in 2700 seconds.

To determine when the pause window should be ended 411, the SCEF 412 can add the NIDD pause duration parameter (which is one hour in this example) to the NIDD pause time parameter (which is 20.09.2021:22.00.00 in this example). Thus, in the present example, when the current time is 20.09.2021:23.00.00 (or, in other words, 11:00 p.m. on Sep. 20, 2021), the SCEF 412 can end 411 the pause window.

At some point in time after the SCEF 412 has ended 411 the pause window, the AS/SCS 416 can send the SCEF 412 another NIDD MT data request 413. For purposes of the present example, it will be assumed that the NIDD MT data request 413 is received by the SCEF 412 at an absolute time of 21.09.2021:06.15.00. In other words, the SCEF 412 receives the NIDD MT data request 413 at 6:15 a.m. on Sep. 21, 2021.

In response to receiving the NIDD MT data request 413, the SCEF 412 determines 415 whether the NIDD MT data request 413 is received during a pause window. As discussed above, in the present example the pause window extends from 10:00 p.m. until 11:00 p.m. each evening beginning on Sep. 20, 2021. Thus, in the present example, the NIDD MT data request 413 is received outside of a pause window.

Because the NIDD MT data request 413 is received outside of a pause window, the SCEF 412 forwards the NIDD MT data request 413 to the MME 410. FIG. 4 shows the SCEF 412 sending an NIDD MT data request 413′ (which corresponds to the NIDD MT data request 413 that the SCEF 412 received from the AS/SCS 416) to the MME 410. The MME 410 responds by returning an NIDD MT data acknowledgement 417 to the SCEF 412. In response to receiving the NIDD MT data acknowledgement 417 from the MME 410, the SCEF 412 sends an NIDD MT data response 419 to the AS/SCS 416 indicating that the data was successfully delivered to the UE.

Because the NIDD pause duration parameter is 86400 seconds, this means that NIDD operations on the SCEF 412 should be paused every 86400 seconds (which is equivalent to 1440 minutes, or 24 hours, or one day) after the time indicated by the NIDD pause time parameter and for the duration indicated by the NIDD pause duration parameter. Thus, the combination of the NIDD pause time parameter, the NIDD pause duration parameter, and the NIDD pause frequency parameter has the effect of creating a pause window for one hour every night, between 10:00 p.m. and 11:00 p.m., beginning on Sep. 20, 2021.

The above discussion has focused on the pause window that starts at 10:00 p.m. on Sep. 20, 2021 and ends at 11:00 p.m. on Sep. 20, 2021. The method 400 shown in FIG. 4 also includes the SCEF 412 starting 421 a pause window at 10:00 p.m. on the following evening (Sep. 21, 2021).

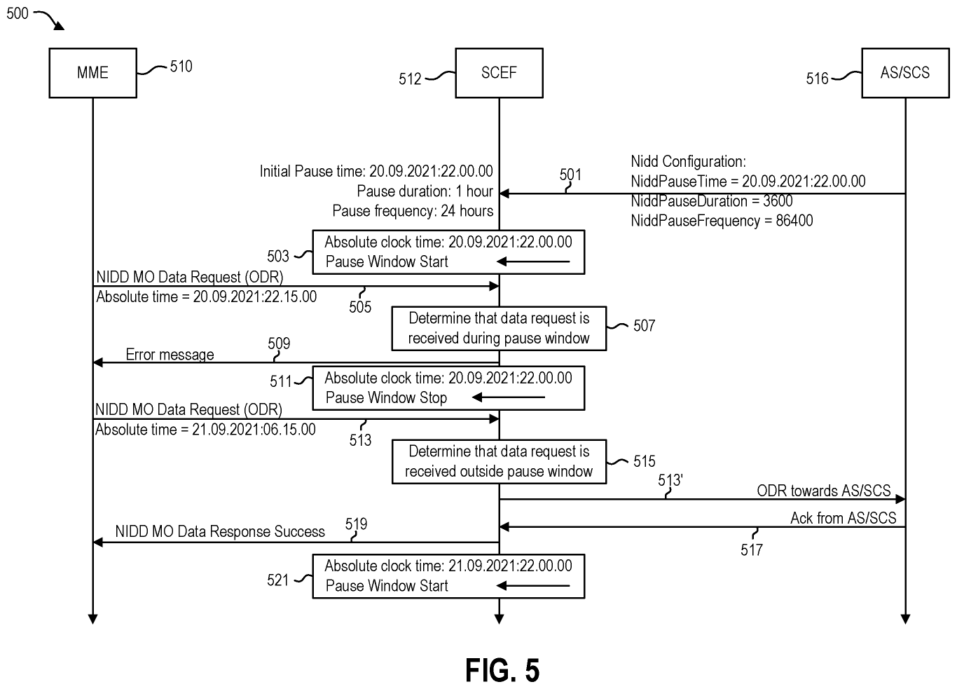

FIG. 5 illustrates an example of a method 500 for enabling NIDD procedures performed by an exposure function to be suspended and resumed in connection with uplink data delivery. The method 500 will be described in relation to an SCEF 512, an MME 510, and an AS/SCS 516. The SCEF 512 is an example of the exposure function 112 in the system 100 shown in FIG. 1. The MME 510 is an example of the mobility entity 110 in the system 100 shown in FIG. 1.

In accordance with the method 500, the AS/SCS 516 can send the SCEF 512 an NIDD configuration message 501. The NIDD configuration message 501 can include an NIDD pause time parameter (NiddPauseTime), an NIDD pause duration parameter (NiddPauseDuration), and an NIDD pause frequency parameter (NiddPauseFrequency).

In some embodiments, the NIDD configuration parameters in the NIDD configuration message 501 can apply to both uplink and downlink communications. For example, the NIDD configuration parameters in the NIDD configuration message 501 can be UL & DL NIDD configuration parameters (such as the UL & DL NIDD configuration parameters 322-1 shown in FIG. 3).

In some embodiments, the NIDD configuration parameters in the NIDD configuration message 501 can apply to uplink communications only. For example, the NIDD configuration parameters in the NIDD configuration message 501 can be UL NIDD configuration parameters (such as the UL NIDD configuration parameters 322-2 shown in FIG. 3).

For purposes of the present example, it will be assumed that the values of the NIDD configuration parameters in the NIDD configuration message 501 are the same as the values of the corresponding parameters in the example that was discussed previously in connection with FIG. 4. Thus, it will be assumed that the value of the NIDD pause time parameter is 20.09.2021:22.00.00, the value of the NIDD pause duration parameter is 3600 seconds (or one hour), and the value of the NIDD pause frequency parameter is 86500 seconds (or 24 hours).

The SCEF 512 can start 503 the pause window at the time indicated by the NIDD pause time parameter. Thus, in the present example, when the current time is 10:00 p.m. on Sep. 20, 2021, the SCEF 512 can start 503 the pause window. The pause window can be scheduled to continue for the length of the NIDD pause duration parameter, which in this example is 5600 seconds (or one hour). Thus, the pause window can be scheduled from 10:00 p.m. until 11:00 p.m.

At some point in time after the SCEF 512 has started the pause window, the MME 510 can send the SCEF 512 an NIDD mobile originated (MO) data request 505. For purposes of the present example, it will be assumed that the NIDD MO data request 505 is received by the SCEF 512 at an absolute time of 20.09.2021:22.15.00. In other words, the SCEF 512 receives the NIDD MO data request 505 at 10:15 p.m. on Sep. 20, 2021.

In response to receiving the NIDD MO data request 505, the SCEF 512 determines 507 whether the NIDD MO data request 505 is received during a pause window. As discussed above, in the present example the pause window extends from 10:00 p.m. until 11:00 p.m. each evening beginning on Sep. 20, 2021. Thus, in the present example, the NIDD MO data request 505 is received during a pause window.

Because the NIDD MO data request 505 is received during a pause window, the SCEF 512 returns an error message 509 to the MME 510. The error message 509 can indicate that the NIDD MO data request 505 is being denied. For example, the error message 509 can include an error code.

In some embodiments, communication between the SCEF 512 and the MME 510 can occur based at least in part on the DIAMETER protocol. An example of an error code that could be used in accordance with the DIAMETER protocol is “DIAMETER 5002: DIAMETER_RESULT_CODE_UNABLE_TO_DELIVER.”

The DIAMETER protocol does not currently support the capability to indicate a time when the request should be retried. In some embodiments, however, the Reliable Data Service (RDS) protocol can be used to indicate a time when the request should be retried. The RDS protocol does not currently support any parameter that could be used to indicate a time when the request should be retried. However, one aspect of the present disclosure involves a modification to the RDS protocol to include a parameter that could be used to indicate a time when the request should be retried. Such a parameter can be referred to herein as a retry after parameter. The retry after parameter can be expressed in units of time (e.g., seconds). In some embodiments, the retry after parameter can indicate an amount of time that the MME 510 should wait before sending another request.

The above discussion about the RDS protocol should not be interpreted as requiring use of the RDS protocol. In some embodiments, communication between the MME 510 and the SCEF 512 can occur without using the RDS protocol. For example, communication between the MME 510 and the SCEF 512 can occur in accordance with the DIAMETER protocol, without using the RDS protocol.

In some embodiments, communication between the MME 510 and the SCEF 512 can occur based at least in part on both the DIAMETER protocol and the RDS protocol. In such embodiments, the NIDD MO data requests (e.g., the NIDD MO data request 505 and the NIDD MO data request 513 shown in FIG. 5) can be accompanied by an RDS I-frame.

In embodiments where communication between the MME 510 and the SCEF 512 is based at least in part on the RDS protocol, the communication between the MME 510 and the SCEF 512 can be non-acknowledged or acknowledged. In embodiments where communication between the MME 510 and the SCEF 512 is based at least in part on the RDS protocol and the communication between the MME 510 and the SCEF 512 is acknowledged, the error message 509 that the SCEF 512 returns to the MME 510 can include a retry after parameter. More specifically, the error message 509 that the SCEF 512 returns to the MME 510 can take the form of an RDS I-frame or S-frame with a SACK bitmap set that includes the retry after parameter. The retry after parameter can indicate a time when the request should be retried.

Proceeding with the discussion of the method 500, the SCEF 512 can determine when the pause window should be ended 511. To make this determination, the SCEF 512 can add the NIDD pause duration parameter (which is one hour in this example) to the NIDD pause time parameter (which is 20.09.2021:22.00.00 in this example). Thus, in the present example, when the current time is 20.09.2021:23.00.00 (or, in other words, 11:00 p.m. on Sep. 20, 2021), the SCEF 512 can end 511 the pause window.

At some point in time after the SCEF 512 has ended the pause window, the MME 510 can send the SCEF 512 another NIDD MO data request 513. For purposes of the present example, it will be assumed that the NIDD MO data request 513 is received by the SCEF 512 at an absolute time of 21.09.2021:06.15.00. In other words, the SCEF 512 receives the NIDD MO data request 513 at 6:15 a.m. on Sep. 21, 2021.

In response to receiving the NIDD MO data request 513, the SCEF 512 determines 515 whether the NIDD MO data request 513 is received during a pause window. As discussed above, in the present example the pause window extends from 10:00 p.m. until 11:00 p.m. each evening beginning on Sep. 20, 2021. Thus, in the present example, the NIDD MO data request 513 is received outside of a pause window.

Because the NIDD MO data request 513 is received outside of a pause window, the SCEF 512 forwards the NIDD MO data request 513 to the AS/SCS 516. FIG. 5 shows the SCEF 512 sending an NIDD MO data request 513′ (which corresponds to the NIDD MO data request 513 that the SCEF 512 received from the MME 510) to the AS/SCS 516. The AS/SCS 516 responds by returning an acknowledgement 517 to the SCEF 512. In response to receiving the acknowledgement 517 from the AS/SCS 516, the SCEF 512 sends an NIDD MO data response 519 to the MME 510 indicating that the data was successfully delivered to the AS/SCS 516.

As discussed above, in the depicted example the combination of the NIDD pause time parameter, the NIDD pause duration parameter, and the NIDD pause frequency parameter has the effect of creating a pause window for one hour every night, between 10:00 p.m. and 11:00 p.m., beginning on Sep. 20, 2021. The above discussion has focused on the pause window that starts at 10:00 p.m. on Sep. 20, 2021 and ends at 11:00 p.m. on Sep. 20, 2021. FIG. 5 also shows the SCEF 512 starting 521 a pause window at 10:00 p.m. on the following evening (Sep. 21, 2021).

The methods 400, 500 shown in FIGS. 4 and 5 have been described in relation to an SCEF and an MME, which are 4G components. As indicated above, however, the techniques disclosed herein can also be implemented in another type of mobile telecommunication network, such as a 5G network. In a 5G implementation, a network exposure function (NEF) can be used in place of the SCEF, and a core access and mobility management function (AMF) can be used in place of the MME.

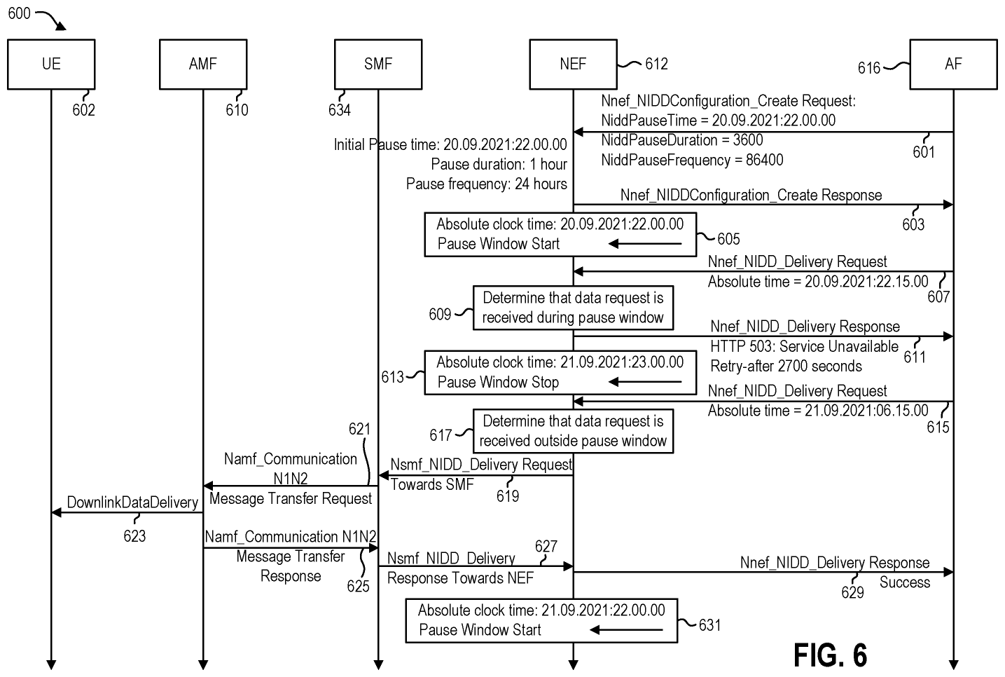

FIG. 6 illustrates an example of a method 600 in a 5G network for enabling NIDD procedures performed by an exposure function to be suspended and resumed in connection with downlink data delivery. The method 600 will be described in relation to a UE 602, an AMF 610, an SMF 634, an NEF 612, and an application function (AF) 616. The NEF 612 is an example of the exposure function 112 in the system 100 shown in FIG. 1. The AMF 610 is an example of the mobility entity 110 in the system 100 shown in FIG. 1.

In accordance with the method 600, the AF 616 can send the NEF 612 an NIDD configuration message. In some embodiments, the NIDD configuration message can take the form of an Nnef_NIDDConfiguration_Create request 601. The Nnef_NIDDConfiguration_Create request 601 can include an NIDD pause time parameter (NiddPauseTime), an NIDD pause duration parameter (NiddPauseDuration), and an NIDD pause frequency parameter (NiddPauseFrequency).

In some embodiments, the NIDD configuration parameters in the Nnef_NIDDConfiguration_Create request 601 can apply to both uplink and downlink communications. For example, the NIDD configuration parameters in the Nnef_NIDDConfiguration_Create request 601 can be UL & DL NIDD configuration parameters (such as the UL & DL NIDD configuration parameters 322-1 shown in FIG. 3).

In some embodiments, the NIDD configuration parameters in the Nnef_NIDDConfiguration_Create request 601 can apply to downlink communications only. For example, the NIDD configuration parameters in the Nnef_NIDDConfiguration_Create request 601 can be DL NIDD configuration parameters (such as the DL NIDD configuration parameters 322-3 shown in FIG. 3).

For purposes of the present example, it will be assumed that the values of the NIDD configuration parameters in the Nnef_NIDDConfiguration_Create request 601 are the same as the values of the corresponding parameters in the examples that were discussed previously. Thus, it will be assumed that the value of the NIDD pause time parameter is 20.09.2021:22.00.00, the value of the NIDD pause duration parameter is 3600 seconds (or one hour), and the value of the NIDD pause frequency parameter is 86500 seconds (or 24 hours).

In response to receiving the Nnef_NIDDConfiguration_Create request 601, the NEF 612 can send an acknowledgement to the AF 616. In some embodiments, the acknowledgement can take the form of an Nnef_NIDDConfiguration_Create response 603.

The NEF 612 can start 605 the pause window at the time indicated by the NIDD pause time parameter. Thus, in the present example, when the current time is 10:00 p.m. on Sep. 20, 2021, the NEF 612 can start 605 the pause window. The pause window can be scheduled to continue for the length of the NIDD pause duration parameter, which in this example is 3600 seconds (or one hour). Thus, the pause window can be scheduled to last from 10:00 p.m. until 11:00 p.m. in the present example.

At some point after the NEF 612 has started 605 the pause window, the AF 616 can send the NEF 612 an NIDD mobile-terminated (MT) data request. In some embodiments, the NIDD MT data request can take the form of an Nnef_NIDD_Delivery request 607. For purposes of the present example, it will be assumed that the Nnef_NIDD_Delivery request 607 is received by the NEF 612 at 20.09.2021:22.15.00. In other words, the NEF 612 receives the Nnef_NIDD_Delivery request 607 at 10:15 p.m. on Sep. 20, 2021.

In response to receiving the Nnef_NIDD_Delivery request 607, the NEF 612 determines 609 whether the Nnef_NIDD_Delivery request 607 is received during a pause window (as defined by the NIDD configuration parameters that were received in the Nnef_NIDDConfiguration_Create request 601). As discussed above, in the present example the pause window extends from 10:00 p.m. until 11:00 p.m. each evening beginning on Sep. 20, 2021. Thus, in the present example, the Nnef_NIDD_Delivery request 607 is received during a pause window.

Because the Nnef_NIDD_Delivery request 607 is received during a pause window, the NEF 612 returns an error message to the AF 616. In some embodiments, the error message can take the form of an Nnef_NIDD_Delivery response 611 with an error code. An example of an error code that could be used is “HTTP 503: Service Unavailable.” In addition, the Nnef_NIDD_Delivery response 611 can also indicate a time when the request should be retried. The time when the request should be retried can be determined in the manner described above.

To determine when the pause window should be ended 613, the NEF 612 can add the NIDD pause duration parameter (which is one hour in this example) to the NIDD pause time parameter (which is 20.09.2021:22.00.00 in this example). Thus, in the present example, when the current time is 20.09.2021:23.00.00 (or, in other words, 11:00 p.m. on Sep. 20, 2021), the NEF 612 can end 613 the pause window.

At some point in time after the NEF 612 has ended 613 the pause window, the AF 616 can send the NEF 612 another Nnef_NIDD_Delivery request 615. For purposes of the present example, it will be assumed that the Nnef_NIDD_Delivery request 615 is received by the NEF 612 at an absolute time of 21.09.2021:06.15.00. In other words, the NEF 612 receives the Nnef_NIDD_Delivery request 615 at 6:15 a.m. on Sep. 21, 2021.

In response to receiving the Nnef_NIDD_Delivery request 615, the NEF 612 determines 617 whether the Nnef_NIDD_Delivery request 615 is received during a pause window. As discussed above, in the present example the pause window extends from 10:00 p.m. until 11:00 p.m. each evening beginning on Sep. 20, 2021. Thus, in the present example, the NEF 612 determines 617 that the Nnef_NIDD_Delivery request 615 is received outside of a pause window.

Because the Nnef_NIDD_Delivery request 615 is received outside of a pause window, the NEF 612 takes the necessary actions to cause the content of the Nnef_NIDD_Delivery request 615 to be delivered to the UE 602. FIG. 6 shows the NEF 612 sending an Nsmf_NIDD_Delivery request 619 toward the SMF 634, the SMF 634 sending an Namf_Communication_N1N2 message transfer request 621 to the AMF 610, the AMF 610 sending a downlink data delivery 623 to the UE 602, the AMF 610 sending an Namf_Communication_N1N2 message transfer response 625 to the SMF 634, the SMF 634 sending an Nsmf_NIDD_Delivery response 627 to the NEF 612, and the NEF 612 sending an Nnef_NIDD_Delivery response 629 to the AF 616 indicating that the data was successfully delivered to the UE 602.

As before, the combination of the NIDD pause time parameter, the NIDD pause duration parameter, and the NIDD pause frequency parameter has the effect of creating a pause window for one hour every night, between 10:00 p.m. and 11:00 p.m., beginning on Sep. 20, 2021. The above discussion has focused on the pause window that starts at 10:00 p.m. on Sep. 20, 2021 and ends at 11:00 p.m. on Sep. 20, 2021. However, the method 600 shown in FIG. 6 also includes the NEF 612 starting 631 a pause window at 10:00 p.m. on the following evening (Sep. 21, 2021).

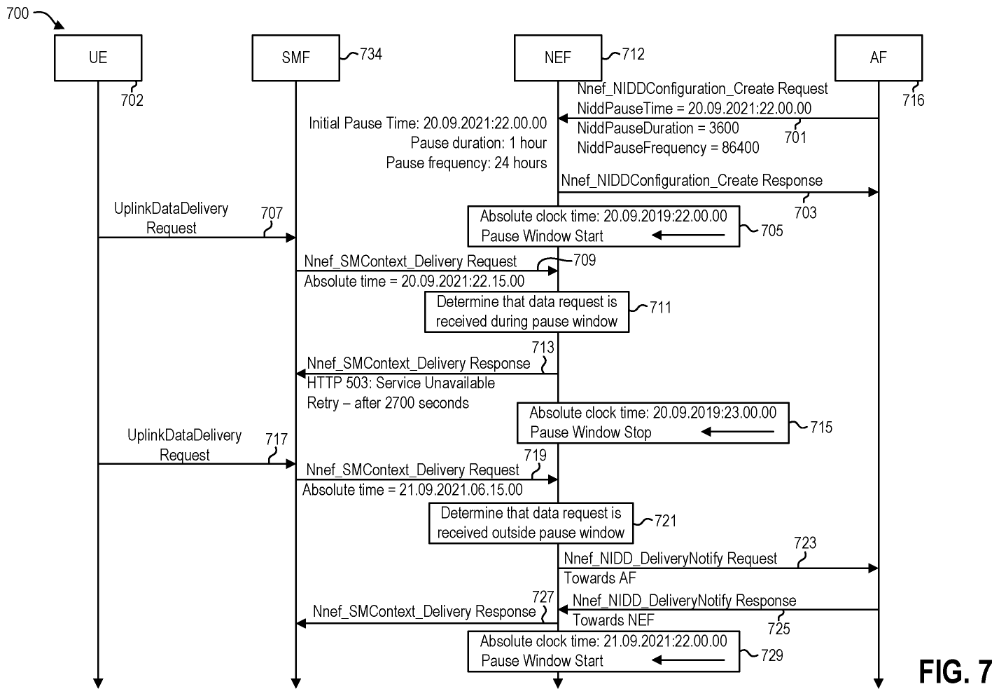

FIG. 7 illustrates an example of a method 700 in a 5G network for enabling NIDD procedures performed by an exposure function to be suspended and resumed in connection with uplink data delivery. The method 700 will be described in relation to a UE 702, an SMF 734, an NEF 712, and an AF 716. The NEF 712 is an example of the exposure function 112 in the system 100 shown in FIG. 1.

In accordance with the method 700, the AF 716 can send the NEF 712 an NIDD configuration message. In some embodiments, the NIDD configuration message can take the form of an Nnef_NIDDConfiguration_Create request 701. The Nnef_NIDDConfiguration_Create request 701 can include an NIDD pause time parameter (NiddPauseTime), an NIDD pause duration parameter (NiddPauseDuration), and an NIDD pause frequency parameter (NiddPauseFrequency).

In some embodiments, the NIDD configuration parameters in the Nnef_NIDDConfiguration_Create request 701 can apply to both uplink and downlink communications. For example, the NIDD configuration parameters in the Nnef_NIDDConfiguration_Create request 701 can be UL & DL NIDD configuration parameters (such as the UL & DL NIDD configuration parameters 322-1 shown in FIG. 3).

In some embodiments, the NIDD configuration parameters in the Nnef_NIDDConfiguration_Create request 701 can apply to downlink communications only. For example, the NIDD configuration parameters in the Nnef_NIDDConfiguration_Create request 701 can be DL NIDD configuration parameters (such as the DL NIDD configuration parameters 322-3 shown in FIG. 3).

For purposes of the present example, it will be assumed that the values of the NIDD configuration parameters in the Nnef_NIDDConfiguration_Create request 701 are the same as the values of the corresponding parameters in the examples that were discussed previously. Thus, it will be assumed that the value of the NIDD pause time parameter is 20.09.2021:22.00.00, the value of the NIDD pause duration parameter is 3600 seconds (or one hour), and the value of the NIDD pause frequency parameter is 86500 seconds (or 24 hours).

In response to receiving the Nnef_NIDDConfiguration_Create request 701, the NEF 712 can send an acknowledgement to the AF 716. In some embodiments, the acknowledgement can take the form of an Nnef_NIDDConfiguration_Create response 703.

The NEF 712 can start 705 the pause window at the time indicated by the NIDD pause time parameter. Thus, in the present example, when the current time is 10:00 p.m. on Sep. 20, 2021, the NEF 712 can start 705 the pause window. The pause window can be scheduled to continue for the length of the NIDD pause duration parameter, which in this example is 3600 seconds (or one hour). Thus, the pause window can be scheduled to last from 10:00 p.m. until 11:00 p.m. in the present example.

At some point after the NEF 712 has started 705 the pause window, the UE 702 can send the SMF 734 an uplink data delivery request 707. In response, the SMF 734 can send the NEF 712 an Nnef_SMContext_Delivery request 709. For purposes of the present example, it will be assumed that the Nnef_SMContext_Delivery request 709 is received by the NEF 712 at 20.09.2021:22.15.00. In other words, the NEF 712 receives the Nnef_SMContext_Delivery request 709 at 10:15 p.m. on Sep. 20, 2021.

In response to receiving the Nnef_SMContext_Delivery request 709, the NEF 712 determines 711 whether the Nnef_SMContext_Delivery request 709 is received during a pause window (as defined by the NIDD configuration parameters that were received in the Nnef_NIDDConfiguration_Create request 701). As discussed above, in the present example the pause window extends from 10:00 p.m. until 11:00 p.m. each evening beginning on Sep. 20, 2021. Thus, in the present example, the Nnef_SMContext_Delivery request 709 is received during a pause window.

Because the Nnef_SMContext_Delivery request 709 is received during a pause window, the NEF 712 returns an error message to the SMF 734. In some embodiments, the error message can take the form of an Nnef_SMContext_Delivery response 713. The Nnef_SMContext_Delivery response 713 can indicate that the Nnef_SMContext_Delivery request 709 is being denied. For example, the Nnef_SMContext_Delivery response 713 can include an error code. An example of an error code that could be used is “HTTP 503: Service Unavailable.” In addition, the Nnef_SMContext_Delivery response 713 can also indicate a time when the request should be retried. The time when the request should be retried can be determined in the manner described above.

To determine when the pause window should be ended 715, the NEF 712 can add the NIDD pause duration parameter (which is one hour in this example) to the NIDD pause time parameter (which is 20.09.2021:22.00.00 in this example). Thus, in the present example, when the current time is 20.09.2021:23.00.00 (or, in other words, 11:00 p.m. on Sep. 20, 2021), the NEF 712 can end 715 the pause window.

At some point in time after the NEF 712 has ended 715 the pause window, the UE 702 can send the SMF 734 another uplink data delivery request 717, and in response the SMF 734 can send the NEF 712 another Nnef_SMContext_Delivery request 719. For purposes of the present example, it will be assumed that the Nnef_SMContext_Delivery request 719 is received by the NEF 712 at an absolute time of 21.09.2021:06.15.00. In other words, the NEF 712 receives the Nnef_SMContext_Delivery request 719 at 6:15 a.m. on Sep. 21, 2021.

In response to receiving the Nnef_SMContext_Delivery request 719, the NEF 712 determines 721 whether the Nnef_SMContext_Delivery request 719 is received during a pause window. As discussed above, in the present example the pause window extends from 10:00 p.m. until 11:00 p.m. each evening beginning on Sep. 20, 2021. Thus, in the present example, the NEF 712 determines 721 that the Nnef_SMContext_Delivery request 719 is received outside of a pause window.

Because the Nnef_SMContext_Delivery request 719 is received outside of a pause window, the NEF 712 takes the necessary actions to cause the content of the Nnef_SMContext_Delivery request 719 to be delivered to the AF 716. FIG. 7 shows the NEF 712 sending an Nnef_NIDD_DeliveryNotify request 723 to the AF 716, the AF 716 sending an Nnef_NIDD_DeliveryNotify response 725 to the NEF 712, and the NEF 712 sending an Nnef_SMContext_Delivery response 727 to the SMF 734 indicating that the data was successfully delivered to the AF 716.

As before, the combination of the NIDD pause time parameter, the NIDD pause duration parameter, and the NIDD pause frequency parameter has the effect of creating a pause window for one hour every night, between 10:00 p.m. and 11:00 p.m., beginning on Sep. 20, 2021. The above discussion has focused on the pause window that starts at 10:00 p.m. on Sep. 20, 2021 and ends at 11:00 p.m. on Sep. 20, 2021. However, the method 700 shown in FIG. 7 also includes the NEF 712 starting 729 a pause window at 10:00 p.m. on the following evening (Sep. 21, 2021).

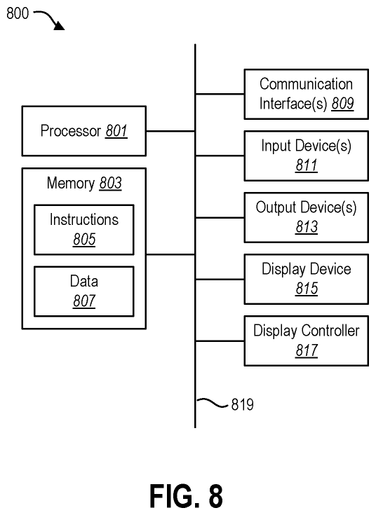

Reference is now made to FIG. 8. One or more computing devices 800 can be used to implement at least some aspects of the techniques disclosed herein. FIG. 8 illustrates certain components that can be included within a computing device 800.

The computing device 800 includes a processor 801 and memory 803 in electronic communication with the processor 801. Instructions 805 and data 807 can be stored in the memory 803. The instructions 805 can be executable by the processor 801 to implement some or all of the methods, steps, operations, actions, or other functionality that is disclosed herein. Executing the instructions 805 can involve the use of the data 807 that is stored in the memory 803. Unless otherwise specified, any of the various examples of modules and components described herein can be implemented, partially or wholly, as instructions 805 stored in memory 803 and executed by the processor 801. Any of the various examples of data described herein can be among the data 807 that is stored in memory 803 and used during execution of the instructions 805 by the processor 801.

Although just a single processor 801 is shown in the computing device 800 of FIG. 8, in an alternative configuration, a combination of processors (e.g., an ARM and DSP) could be used.

The computing device 800 can also include one or more communication interfaces 809 for communicating with other electronic devices. The communication interface(s) 809 can be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computing device 800 can also include one or more input devices 811 and one or more output devices 813. Some examples of input devices 811 include a keyboard, mouse, microphone, remote control device, button, joystick, trackball, touchpad, and lightpen. One specific type of output device 813 that is typically included in a computing device 800 is a display device 815. Display devices 815 used with embodiments disclosed herein can utilize any suitable image projection technology, such as liquid crystal display (LCD), light-emitting diode (LED), gas plasma, electroluminescence, or the like. A display controller 817 can also be provided, for converting data 807 stored in the memory 803 into text, graphics, and/or moving images (as appropriate) shown on the display device 815. The computing device 800 can also include other types of output devices 813, such as a speaker, a printer, etc.

The various components of the computing device 800 can be coupled together by one or more buses, which can include a power bus, a control signal bus, a status signal bus, a data bus, etc. For the sake of clarity, the various buses are illustrated in FIG. 8 as a bus system 819.

The techniques disclosed herein can be implemented in hardware, software, firmware, or any combination thereof, unless specifically described as being implemented in a specific manner. Any features described as modules, components, or the like can also be implemented together in an integrated logic device or separately as discrete but interoperable logic devices. If implemented in software, the techniques can be realized at least in part by a non-transitory computer-readable medium having computer-executable instructions stored thereon that, when executed by at least one processor, perform some or all of the steps, operations, actions, or other functionality disclosed herein. The instructions can be organized into routines, programs, objects, components, data structures, etc., which can perform particular tasks and/or implement particular data types, and which can be combined or distributed as desired in various embodiments.

The term “processor” can refer to a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, or the like. A processor can be a central processing unit (CPU). In some embodiments, a combination of processors (e.g., an ARM and DSP) could be used to implement some or all of the techniques disclosed herein.

The term “memory” can refer to any electronic component capable of storing electronic information. In some contexts, the term memory can include either volatile or non-volatile memory. Memory may be embodied as random access memory (RAM), read-only memory (ROM), magnetic disk storage media, optical storage media, flash memory devices in RAM, on-board memory included with a processor, erasable programmable read-only memory (EPROM), electrically erasable programmable read-only memory (EEPROM) memory, registers, and so forth, including combinations thereof.

The steps, operations, and/or actions of the method 300s described herein may be interchanged with one another without departing from the scope of the claims. In other words, unless a specific order of steps, operations, and/or actions is required for proper functioning of the method 300 that is being described, the order and/or use of specific steps, operations, and/or actions may be modified without departing from the scope of the claims.

The term “determining” (and grammatical variants thereof) can encompass a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there can be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for enabling non-IP data delivery (NIDD) procedures to be suspended and resumed, the method being implemented by an exposure function in a mobile telecommunication network, the method comprising:
receiving a plurality of configuration parameters;
defining a pause window based on the plurality of configuration parameters, wherein the NIDD procedures are suspended during the pause window;
receiving a request to deliver non-IP data;
determining whether the request to deliver the non-IP data is received during the pause window;
denying the request to deliver the non-IP data in response to determining that the request to deliver the non-IP data is received during the pause window; and
allowing the request to deliver the non-IP data in response to determining that the request to deliver the non-IP data is received outside of the pause window.

2. The method of claim 1, wherein the plurality of configuration parameters comprise:
a pause time parameter that indicates a start time for the pause window;
a pause duration parameter that indicates a duration of the pause window; and
a pause frequency parameter that indicates how frequently the pause window should be repeated.

3. The method of claim 2, wherein the plurality of configuration parameters apply to both downlink communications and uplink communications.

4. The method of claim 2, wherein the plurality of configuration parameters apply to only one of downlink communications or uplink communications.

5. The method of claim 2, further comprising resetting the pause time parameter based at least in part on the pause frequency parameter in response to expiration of the pause window.

6. The method of claim 1, wherein the plurality of configuration parameters are received from at least one of an application server (AS), a service capability server (SCS), or an application function (AF).

7. The method of claim 1, wherein the plurality of configuration parameters are received from a network operator.

8. The method of claim 1, wherein the request to deliver the non-IP data is a mobile originated data request.

9. The method of claim 1, wherein the request to deliver the non-IP data is a mobile terminated data request.

10. The method of claim 1, further comprising sending an error message to an entity that sent the request to deliver the non-IP data, wherein the error message indicates when the request to deliver the non-IP data should be retried.

11. The method of claim 1, wherein the exposure function is selected from the group consisting of a service capability exposure function (SCEF) and a network exposure function (NEF).

12. The method of claim 1, further comprising:
receiving an updated value for at least one of the plurality of configuration parameters; and
modifying the pause window based on the updated value.

13. A system for enabling non-IP data delivery (NIDD) procedures to be suspended and resumed, comprising:
one or more processors;
memory in electronic communication with the one or more processors;
a plurality of configuration parameters stored in the memory, the plurality of configuration parameters defining a pause window during which the NIDD procedures are suspended; and
instructions stored in the memory, the instructions being executable by the one or more processors to:
receive a request to deliver non-IP data;
determine whether the request to deliver the non-IP data is received during the pause window;
deny the request to deliver the non-IP data in response to determining that the request to deliver the non-IP data is received during the pause window; and
allow the request to deliver the non-IP data in response to determining that the request to deliver the non-IP data is received outside of the pause window.

14. The system of claim 13, wherein the plurality of configuration parameters comprise:
a pause time parameter that indicates a start time for the pause window;
a pause duration parameter that indicates a duration of the pause window; and
a pause frequency parameter that indicates how frequently the pause window should be repeated.

15. The system of claim 14, wherein the instructions are additionally executable by the one or more processors to, in response to expiration of the pause window, reset the pause time parameter based at least in part on the pause frequency parameter.

16. The system of claim 13, wherein the request to deliver the non-IP data is a mobile originated data request.

17. The system of claim 13, wherein the request to deliver the non-IP data is a mobile terminated data request.

18. The system of claim 13, wherein:
the instructions are additionally executable by the one or more processors to send an error message to an entity that sent the first data request; and
the error message indicates when the first data request should be retried.

19. The system of claim 13, further comprising an access point that is configured in accordance with the plurality of configuration parameters for a group of subscribers.

20. A method for enabling non-IP data delivery (NIDD) procedures to be suspended and resumed, the method comprising:
configuring an exposure function with a plurality of configuration parameters that define a pause window during which the NIDD procedures are suspended;
sending a first data request to the exposure function during the pause window;
receiving an error message from the exposure function in response to the first data request;
sending a second data request to the exposure function outside of the pause window; and
receiving an acknowledgement from the exposure function in response to the second data request.
